(19) United States
(12) Patent Application Publication
(10) Pub. No.: US 2013/0093697 A1
(43) Pub. Date: Apr. 18, 2013

(54) TOUCH PANEL DISPLAY AND ASSEMBLY PROCESS THEREOF

(71) Applicant: Wei-Hao SUN, Taoyuan County (TW)

(72) Inventor: Wei-Hao SUN, Taoyuan County (TW)

(21) Appl. No.: 13/456,673

(22) Filed: Apr. 26, 2012

Related U.S. Application Data
(60) Provisional application No. 61/548,440, filed on Oct. 18, 2011.

(51) Int. Cl. G06F 3/041; B32B 37/12

(52) U.S. Cl. 345/173; 156/292

(57) ABSTRACT

A touch panel display is provided. The display includes a display module and a transparent top plate disposed above the display module. The transparent top plate has a touch surface opposite to the display module. A spacer is disposed between the display module and the transparent top plate to form a first cavity therebetween. The spacer includes a first adhesive film attached to the display module, a second adhesive film attached to the transparent top plate and a hard transparent layer sandwiched between the first and second adhesive films. An assembly process and a touch sensing module thereof are also disclosed.

### CROSS REFERENCE TO RELATED APPLICATIONS

This application claims the benefit of U.S. Provisional Application No. 61/548,440, filed Oct. 18, 2011, which is incorporated by reference herein.

### BACKGROUND OF THE INVENTION

1. Field of the Invention

The invention relates to a touch panel display technology, and in particular to a touch panel display and an assembly process thereof.

2. Description of the Related Art

Flat display devices, such as liquid crystal display (LCD) devices, organic light-emitting display (OLED) devices, MEMS display devices, and electrophoretic display (EPD) devices, have several advantages such as thin profiles, light weights and low power consumption when compared to conventional cathode ray tube (CRT) display devices. Moreover, the cost of the flat display device is reduced as the technology of the manufacturing process improves, such that the flat display device has become more and more popular. In order to increase the convenience in use, a touch sensing module (which is also referred to as a touch window) has further been integrated into the flat display device to form a touch panel display and is widely employed in various electronic products, such as portable personal computers, personal digital assistants (PDAs), mobile phones, digital camera, and the like. The touch sensing module is typically integrated into the flat display device by attaching the touch sensing module to the flat display device via a double side tape or an adhesive film. However, during the assembly process of the touch panel display, an air gap is formed between the touch sensing module and the flat display device in the case of using a double side tape. Also, bubbles may be formed in the adhesive film in the case of using the adhesive film. Both the air gap and bubbles may degrade the optical properties of the touch panel display.

Accordingly, there exists a need in the art for development of a novel touch panel display and a novel assembly process thereof, capable of mitigating or eliminating the aforementioned problems.

### BRIEF SUMMARY OF THE INVENTION

A detailed description is given in the following embodiments with reference to the accompanying drawings. A touch panel display and an assembly process and a touch sensing module thereof are provided. An exemplary embodiment of a touch panel display comprises a display module and a transparent top plate disposed above the display module. The transparent top plate has a touch surface opposite to the display module. A spacer is disposed between the display module and the transparent top plate to form a first cavity therebetween. The spacer comprises a first adhesive film attached to the display module, a second adhesive film attached to the transparent top plate and a first hard transparent layer sandwiched between the first and second adhesive films.

An exemplary embodiment of an assembly process for a touch panel display comprises providing a transparent top plate having a touch surface. A display module is provided and attached to the transparent top plate by a first spacer, such that the touch surface is opposite to the display module and a first cavity is formed between the display module and the transparent top plate. The spacer includes a first adhesive film attached to the display module, a second adhesive film attached to the transparent top plate and a hard transparent layer sandwiched between the first and second adhesive films.

An exemplary embodiment of a touch sensing module for a touch panel display comprises a touch sensing structure and a transparent cover substrate disposed above the touch sensing structure. The touch sensing structure has a touch surface opposite to the touch sensing structure. A spacer is disposed between the touch sensing structure and the transparent cover substrate to form a cavity therebetween. The spacer comprises a first adhesive film attached to the touch sensing structure, a second adhesive film attached to the transparent cover substrate and a hard transparent layer sandwiched between the first and second adhesive films.

### BRIEF DESCRIPTION OF DRAWINGS

The invention can be more fully understood by reading the subsequent detailed description and examples with references made to the accompanying drawings, wherein:

FIGS. 1A to 1D are cross sections of an exemplary embodiment of an assembly process for an on-cell touch panel display;

FIGS. 2A to 2C are cross sections of an exemplary embodiment of an touch sensing module for a touch panel display according to the invention;

FIGS. 3A to 3C are cross sections of an exemplary embodiment of an assembly process for a touch panel display according to the invention; and

FIG. 4 is a cross section of another exemplary embodiment of a touch panel display according to the invention.

### DETAILED DESCRIPTION OF INVENTION

The following description is of the best-contemplated mode of carrying out the invention. This description is provided for the purpose of illustrating the general principles of the invention and should not be taken in a limiting sense. The scope of the invention is best determined by reference to the appended claims.

The following embodiments discloses a touch panel display and an assembly process and a touch sensing module thereof, capable of enhancing the adhesion between a cover substrate and a touch sensing structure integrated into a display module, between a touch sensing module/touch sensing plate and a display module, or between a cover substrate and a touch sensing structure in a touch sensing module and improving the uniformity in the plane height of the cover substrate, touch sensing plate, or touch sensing module, while maintaining the optical properties of the touch panel display.

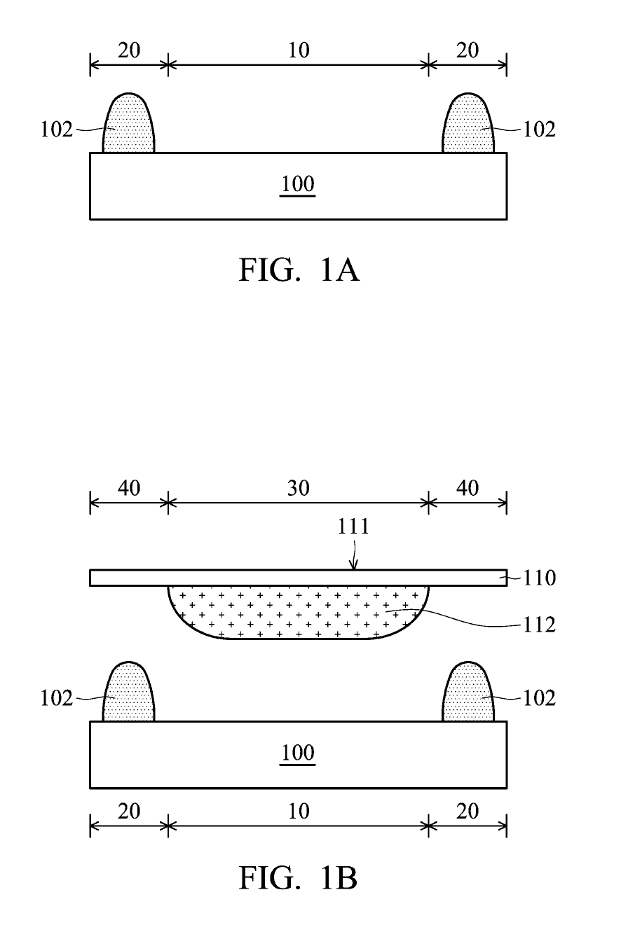

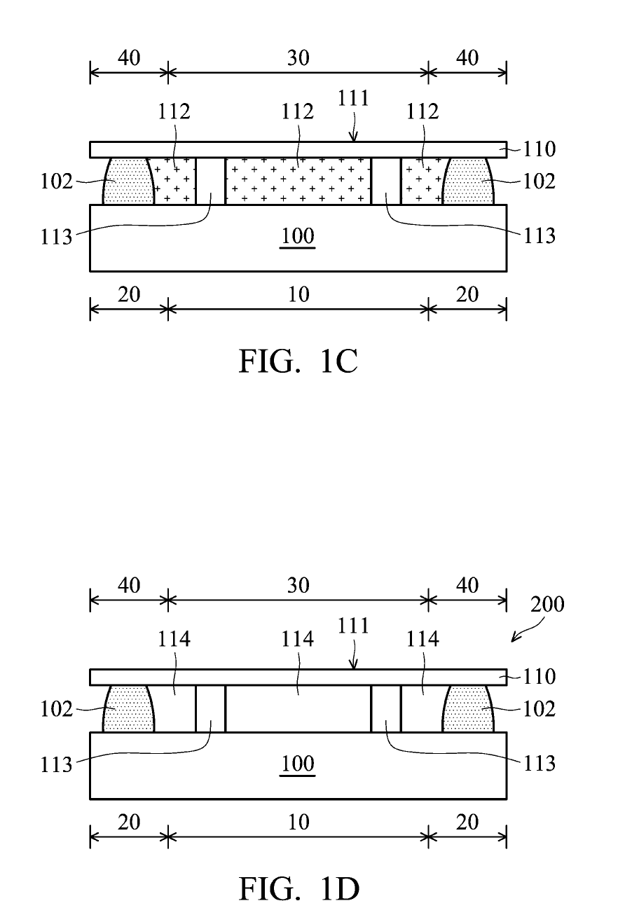

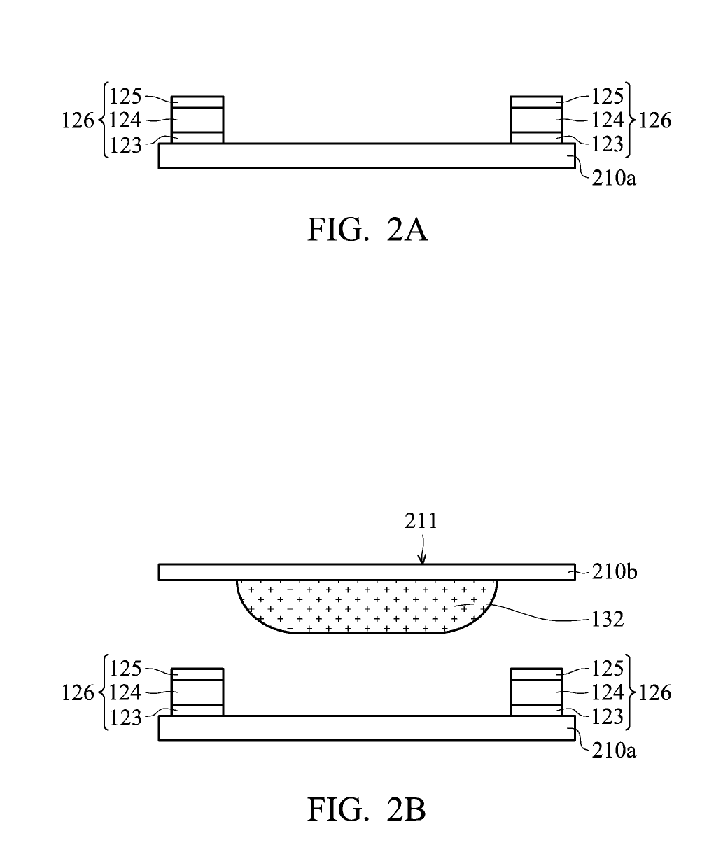

FIGS. 1A to 1D illustrate an assembly process for an on-cell touch panel display. Referring to FIG. 1A, a display module 100 having a display region 10 and a non-display region 20 enclosing the display region 10 is provided. The display module 100 may comprise a flat display device, such as an LCD, OLED, MEMS display or EPD device. In order to simplify the diagram, only a flat substrate is depicted. A spacer 102 (which is also referred to as a dam) is formed on the display module 100 and corresponds to the non-display region 20 to substantially enclose the display region 10. The spacer 102 may be formed by coating an ultra-violet (UV) curable material with a viscosity in a range of about 500 cps to 50000 cps (not shown) onto the region where the spacer 120 is to be formed. Thereafter, the UV curable material is cured by UV illumination, to form the spacer 102 on the display module 100.

Referring to FIG. 1B, a touch sensing module 110 is provided above the display module 100 having the spacer 102 thereon. The touch sensing module 110 may comprise a touch sensing structure and a transparent cover substrate (such as a glass or other transparent substrate well known in the art) thereon for providing a touch surface 111, wherein the touch sensing structure may comprise a plurality of touch sensing electrodes (which is also referred to as a touch sensing array), a plurality of insulating layers and an optional transparent bottom substrate (such as a glass or other transparent substrate well known in the art) opposite to the transparent cover substrate. In order to simplify the diagram, only a flat layer is depicted.

The touch sensing module 110 has a touch sensing region 30 and a peripheral region 40 enclosing the touch sensing region 30. The touch sensing region 30 is substantially aligned to the display region 10 of the display module 100 and the peripheral region 40 is substantially aligned to the non-display region 20 of the display module 100. A liquid optical clear adhesive (LOCA) 112, such as UV glue with a viscosity in a range of about 500 cps to 5000 cps, is coated onto the touch sensing module 110 and faces to display module 100 under the touch sensing module 110.

Referring to FIGS. 1C and 1D, the touch sensing module 110 is attached to the display module 100 by the LOCA 112 and the spacer 102, to form an on-cell touch panel display 200. In FIG. 1C, a pre-cured process is performed in the LOCA 112 by UV illumination, thereby forming a pre-cured glue portion 113 near the spacer 102 and leaving a portion of the LOCA 112 uncured. The pre-cured glue portion 113 may mitigate the misalignment between the touch sensing module 110 and the display module 100 due to a shifted touch sensing module 110 when the display module 100 is being covered with the touch sensing module 110.

In FIG. 1D, a main-curing process is subsequently performed by laterally illuminating a UV light (not shown) through the spacer 102, such that the uncured LOCA 112 is completely cured to form the cured glue 114, which is also referred to as a transparent adhesive filler. The spacer 102, the pre-cured glue portion 113 and the transparent adhesive filler (i.e., the cured glue) 114 make the touch sensing module 110 fixed onto the display module 100. As a result, no air gap or bubble is formed during the assembly process. Accordingly, the optical properties of the touch panel display are not degraded.

However, the spacer 102 formed of UV curable material has poor adhesion and low transmittance (which may reduce the adhesion of the transparent adhesive filler 114 due to poor UV illumination in the main-curing process), and thus delamination may be induced. Accordingly, the reliability of the on-cell touch panel display 200 is reduced. Moreover, since the stiff property of the spacer 102, which is formed by curing of a liquid UV curable material, is poor, it is hard to control the plane height uniformity of the touch sensing module 110. Additionally, the pre-cure process may complicate the assembly process for the touch panel display 200. Also, stress concentration may occur at the pre-cured glue portion 113 so as to induce color shift or mura defects in the touch panel display 200.

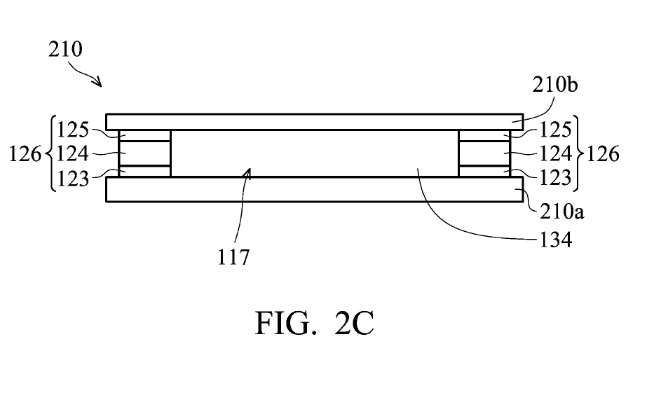

Referring to FIG. 2C, an exemplary embodiment of a touch sensing module 210 according to the invention is illustrated. In the embodiment, the touch sensing module 210 may comprise a touch sensing structure 210a and a transparent cover substrate 210b disposed above the touch sensing structure 210a, wherein the transparent cover substrate 210b has a touch surface 211 opposite to the touch sensing structure 210a.

A spacer 126 is disposed between the touch sensing structure 210a and the transparent cover substrate 210b to form a cavity 117 therebetween. Moreover, a transparent adhesive filler 134 is disposed within the cavity 117. In the embodiment, in particular, the spacer 126 may comprise an adhesive film 123 attached to the touch sensing structure 210a, another adhesive film 125 attached to the transparent cover substrate 210b and a hard transparent layer 124 sandwiched between the adhesive films 123 and 125. Accordingly, the spacer 126 is also referred to as a tape dam.

FIGS. 2A to 2C illustrate an exemplary embodiment of an assembly process for a touch sensing module 210 according to the invention. Elements in FIGS. 2A to 2C that are the same as those in FIGS. 1A to 1D are labeled with the same reference numbers as in FIGS. 1A to 1D and are not described again for brevity. Referring to FIG. 2A, a touch sensing structure 210a is provided. In the embodiment, the touch sensing structure 210a may comprise a plurality of touch sensing electrodes (i.e., a touch sensing array), a plurality of insulating layers and an optional transparent bottom substrate (such as a glass or other transparent substrate well known in the art). In order to simplify the diagram, only a flat layer is depicted. Next, a spacer 126 is formed on the touch sensing structure 210a. In particular, the spacer 126 may comprise a hard transparent layer 124 sandwiched between two adhesive films 123 and 125, wherein the adhesive film 123 is attached to the touch sensing structure 210a. In the embodiment, the hard transparent layer 124 may have a high transmittance (e.g., greater than 30%) and comprise polycarbonate or glass. The thickness of the hard transparent layer 124 can be adjusted according to a desired spacer height.

Referring to FIG. 2B, a transparent cover substrate 210b, such as a glass or other transparent substrate well known in the art, is provided above the touch sensing structure 210a having the spacer 126 thereon. The transparent cover substrate 210b has a touch surface 211 opposite to the touch sensing structure 210a. A LOCA 132, which may be composed of the same material as that of the LOCA 112 (as indicated in FIG. 1B), is coated onto the transparent cover substrate 210b and faces to the touch sensing structure 210a under the transparent cover substrate 210b.

Referring to FIG. 2C, the transparent cover substrate 210b is attached to the touch sensing structure 210a by the adhesive film 125 of the tape dam (i.e. spacer 126) to form a cavity 117 between the transparent cover substrate 210b and the touch sensing structure 210a, such that the LOCA 132 is completely filled into the cavity 117. During the attachment process, a curing process is performed in the LOCA 132 by laterally illuminating a UV light (not shown) through the spacer 126, to form a transparent adhesive filler 124 (i.e., a cured glue) between the transparent cover substrate 210b and the touch sensing structure 210a, and thus the touch sensing module 210 is completed.

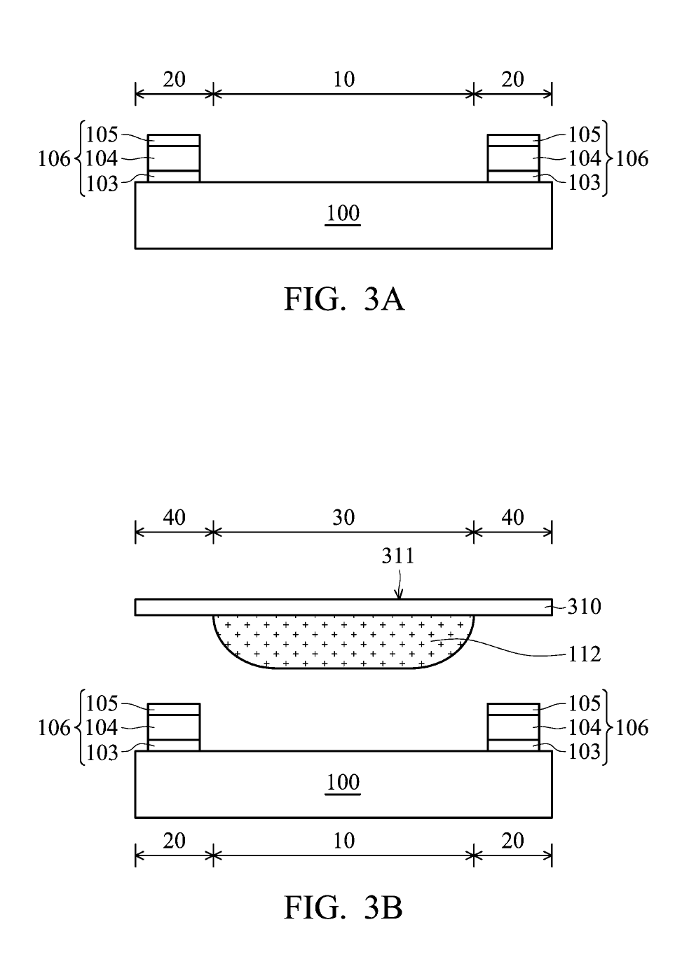

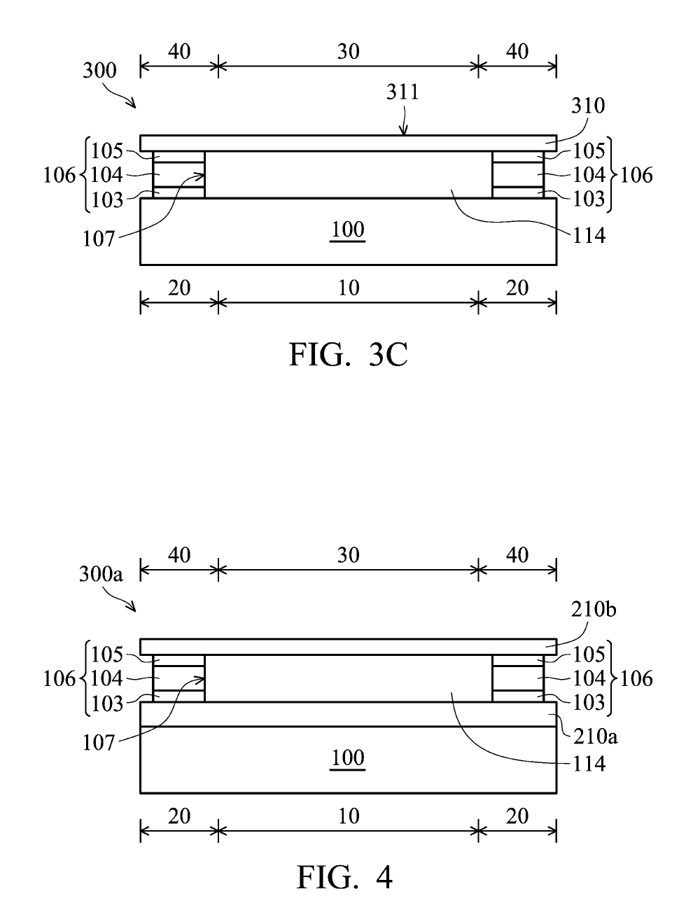

FIG. 3C illustrates an exemplary embodiment of a touch panel display 300 according to the invention. Elements in FIG. 3C that are the same as those in FIG. 1D are labeled with the same reference numbers as in FIG. 1D and are not described again for brevity. In the embodiment, the touch panel display 300 may comprise a display module 100 and a transparent top plate 310 disposed above the display module 100. Moreover, the transparent top plate 310 has a touch surface 311 opposite to the display module 100.

A spacer 106 is disposed between the display module 100 and the transparent top plate 310 to form a cavity 107 therebetween. In the embodiment, the spacer 106 may have a structure similar to or the same as that of the spacer 126 shown in FIG. 2A. For example, the spacer 106 may comprise a hard transparent layer 104 sandwiched between two adhesive films 103 and 105, wherein the hard transparent layer 104 is composed a material similar to or the same as that of the hard transparent layer 124 shown in FIG. 2A. Moreover, the adhesive film 103 is attached to the display module 100 and the adhesive film is attached to the transparent top plate 310. In the embodiment, the touch panel display 300 may further comprise a transparent adhesive filler 114 within the cavity 107. The transparent adhesive filler 114 may be composed of a material similar to or the same as that of the adhesive filler 134 shown in FIG. 2C.

In one embodiment, the transparent top plate 310 comprises a cover substrate (not shown) and a touch sensing structure (not shown) thereunder. For example, the transparent top plate 310 may be implemented as a touch sensing module 210, as shown in FIG. 2C. In another embodiment, the transparent top plate 310 may be implemented as a touch sensing plate. Unlike the touch sensing module 210 shown in FIG. 2C, the term of “touch sensing plate” may comprise a cover substrate (not shown) where a touch sensing array (not shown) is integrated thereon.

FIGS. 3A to 3C illustrate an exemplary embodiment of an assembly process for a touch panel display 300 according to the invention. Elements in FIGS. 3A to 3C that are the same as those in FIGS. 1A to 1D are labeled with the same reference numbers as in FIGS. 1A to 1D and are not described again for brevity. Referring to FIG. 3A, a display module 100 having a display region 10 and a non-display region 20 is provided. A spacer 106 is formed on the display module 100 and corresponds to the non-display region 20. In the embodiment, in particular, the spacer 106 may comprise a hard transparent layer 104 sandwiched between two adhesive films 103 and 105, wherein the adhesive film 103 is attached to the display module 100. Moreover, the hard transparent layer 104 may have a high transmittance (e.g., greater than 30%) and comprise polycarbonate or glass. The thickness of the hard transparent layer 104 can be adjusted according to a desired spacer height.

Referring to FIG. 3B, a transparent top plate 310 having a touch surface 311 is provided above the display module 100 having the spacer 106 thereon, wherein the transparent top plate 310 has a touch sensing region 30 and a peripheral region 40 enclosing the touch sensing region 30. The touch sensing region 30 is substantially aligned to the display region 10 of the display module 100 and the peripheral region 40 is substantially aligned to the non-display region 20 of the display module 100. A LOCA 112, such as UV glue, is coated onto the transparent top plate 310 and faces to the display module 100 under the transparent top plate 310.

Referring to FIG. 3C, the transparent top plate 310 is attached to the display module 100 by the adhesive film 105 of the tape dam (i.e. spacer 106) to form a cavity 107 between the transparent top plate 310 and the display module 100, such that the LOCA 112 is completely filled into the cavity 107. During the attachment process, a curing process is performed in the LOCA 112 by laterally illuminating a UV light (not shown) through the spacer 106, to form a transparent adhesive filler 114 (i.e., a cured glue) between the transparent top plate 310 and the display module 100, and thus the touch panel display 300 is completed. In this embodiment, the touch panel display 300 is implemented as an on-cell touch panel display. Accordingly, the transparent top plate 310 may comprise a cover substrate (not shown) and a touch sensing structure (not shown) thereunder. For example, the transparent top plate 310 may be implemented as a touch sensing module 210, as shown in FIG. 2C. Alternatively, the transparent top plate 310 may be implemented as a touch sensing plate which may comprise a cover substrate (not shown) where a touch sensing array (not shown) is integrated thereon.

FIG. 4 illustrates another exemplary embodiment of a touch panel display 300a according to the invention. Elements in FIG. 4 that are the same as those in FIG. 3C are labeled with the same reference numbers as in FIG. 3C and are not described again for brevity. In the embodiment, the touch panel display 300a has a structure similar to that of the touch panel display 300 shown in FIG. 3C. Unlike the transparent top plate 310 of the touch panel display 300, the transparent top plate of the touch panel display 300a is implemented as a cover substrate 210b (as shown in FIG. 2B). Moreover, the display module 100 may further comprise a touch sensing structure 210a (as shown in FIG. 2A) integrated thereon, wherein the touch sensing structure 210a may comprise a touch sensing array (not shown). In this embodiment, the touch panel display 300a may be implemented as an in-cell touch panel display, such that the spacer 106 is employed to attach the transparent top plate (i.e., the cover substrate 210b) to the display module 100 having a touch sensing structure 210a thereon.

According to the aforementioned embodiments, since no air gap or bubble is formed during the assembly process, the optical properties of the touch panel display are not degraded. Moreover, the spacer (i.e., tape dam) has better adhesion and transmittance than that of the UV dam due to the use of adhesive films and the use of the hard transparent layer, and thus delamination may be eliminated, thereby increasing the reliability of the touch panel display. Moreover, compared to using the UV dam, the plane height uniformity of the touch sensing module or a cover substrate can be easily controlled by the use of the hard transparent layer as a portion of the spacer.

Additionally, since the cover substrate can be fixed onto the touch sensing structure or the display module through the tape dam/spacer and since the touch sensing module can also be fixed onto the display module through the tape dam/spacer, it is not necessary to perform the conventional pre-cure process to prevent the cover substrate or the touch sensing module from misalignment. Accordingly, color shift or mura defects in touch panel displays can be eliminated.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch panel display, comprising:
a display module;
a transparent top plate disposed above the display module, having a touch surface opposite to the display module; and
a first spacer disposed between the display module and the transparent top plate to form a first cavity therebetween, comprising:
a first adhesive film attached to the display module;
a second adhesive film attached to the transparent top plate; and
a first hard transparent layer sandwiched between the first and second adhesive films.

2. The display of claim 1, further comprising a first transparent adhesive filler disposed within the first cavity.

3. The display of claim 1, wherein the first hard transparent layer comprises polycarbonate or glass.

4. The display of claim 1, wherein the transparent top plate is a cover substrate and a touch sensing structure comprising a touch sensing array is integrated onto the display module.

5. The display of claim 1, wherein the transparent top plate is a touch sensing module comprising a cover substrate and a touch sensing structure thereunder.

6. The display of claim 5, wherein the touch sensing module further comprises a second spacer disposed between the cover substrate and touch sensing structure to form a second cavity therebetween, and wherein the second spacer comprises:
a third adhesive film attached to the touch sensing structure;
a fourth adhesive film attached to the cover substrate; and
a second hard transparent layer sandwiched between the third and fourth adhesive films.

7. The display of claim 6, further comprising a second transparent adhesive filler disposed within the second cavity.

8. The display of claim 7, wherein the second hard transparent layer comprises polycarbonate or glass.

9. The display of claim 1, wherein the transparent top plate is a touch sensing plate comprising a cover substrate and a touch sensing array integrated thereon.

10. An assembly process for a touch panel display, comprising:
providing a display module; and
providing a transparent top plate having a touch surface and attaching the transparent top plate to the display module by a first spacer, such that the touch surface is opposite to the display module and a first cavity is formed between the display module and the transparent top plate,
wherein the first spacer, comprises:
a first adhesive film attached to the display module;
a second adhesive film attached to the transparent top plate; and
a first hard transparent layer sandwiched between the first and second adhesive films

11. The process of claim 10, further filling a first transparent adhesive filler within the first cavity.

12. The process of claim 10, wherein the first hard transparent layer comprises polycarbonate or glass.

13. The process of claim 10, wherein the transparent top plate is a cover substrate and a touch sensing structure comprising a touch sensing array is integrated onto the display module.

14. The process of claim 10, wherein the transparent top plate is a touch sensing module comprising a cover substrate and a touch sensing structure thereunder.

15. The process of claim 14, further comprising attaching the cover substrate to the touch sensing structure by a second spacer to form a second cavity therebetween, wherein the second spacer comprises:
a third adhesive film attached to the touch sensing structure;
a fourth adhesive film attached to the cover substrate; and
a second hard transparent layer sandwiched between the third and fourth adhesive films.

16. The process of claim 15, further comprising a second transparent adhesive filler disposed within the second cavity.

17. The process of claim 16, wherein the second hard transparent layer comprises polycarbonate or glass.

18. The process of claim 10, wherein the transparent top plate is a touch sensing plate comprising a cover substrate and a touch sensing array integrated thereon.

19. A touch sensing module for a touch panel display, comprising:
a touch sensing structure;
a transparent cover substrate disposed above the touch sensing structure, having a touch surface opposite to the touch sensing structure; and
a spacer disposed between the touch sensing structure and the transparent cover substrate to form a cavity therebetween, comprising:
a first adhesive film attached to the touch sensing structure;
a second adhesive film attached to the transparent cover substrate; and
a hard transparent layer sandwiched between the first and second adhesive films.

20. The module of claim 19, further comprising a transparent adhesive filler disposed within the cavity.

21. The module of claim 19, wherein the first hard transparent layer comprises polycarbonate or glass.
